(19) United States
(12) Patent Application Publication
(10) Pub. No.: US 2025/0375056 A1
(43) Pub. Date: Dec. 11, 2025

(54) ARTIFICIAL CHRISTMAS TREE INTEGRATED WITH A CAT TOWER

(71) Applicant: Stephen O’Neill, Waltham, MA (US)

(72) Inventor: Stephen O’Neill, Waltham, MA (US)

(21) Appl. No.: 19/233,162

(22) Filed: Jun. 10, 2025

Related U.S. Application Data
(60) Provisional application No. 63/658,529, filed on Jun. 11, 2024.

(51) Int. Cl. A47G 33/06; A01K 1/035; A01K 15/02

(52) U.S. Cl. CPC A47G 33/06; A01K 1/035; A01K 15/024

(57) ABSTRACT

The present invention discloses an artificial Christmas tree integrated with a cat tower. The tree comprises a base and a trunk comprising one or more pathways. The cat tower further comprises at least one platform disposed within at least one hollow member. Each hollow member comprises at least one opening and at least one platform disposed adjacent to the opening. The platform extends from at least a portion of interior surface of the hollow member and extends beyond the hollow member through the opening. The tree further comprises a pathway extending from a base of the tree and connects the openings configured on the trunk. The pathway enables the cats to climb at different height levels of the tree using the platform. The tree integrated with the cat tower provides a structure where cats could play and rest, and provides relief to pet owners from damage of household things.

### CROSS REFERENCE TO RELATED APPLICATION

This application claims the priority benefit of the U.S. Patent Application No. 63/658,529 filed on Jun. 11, 2024, the contents of which are hereby incorporated by reference in their entirety.

### TECHNICAL FIELD

The present invention generally relates to an artificial Christmas tree. More specifically, the present invention relates to an artificial Christmas tree integrated with a cat tower.

### BACKGROUND

Pet owners with Christmas trees encounter constant challenges during the holiday season. In particular, cats are known for their fascination for the features of the Christmas trees including both artificial and natural Christmas trees. The artificial Christmas tree typically comprises a metal frame containing a base stand, a center pole projecting vertically from the center of the base and tree branches attached to the center pole. The tree branches are decorated with ornaments such as shiny baubles, tinsel, and other reflective decorations, and dangling decorations. The dangling decorations mimicking the movements of small animals or birds, and shiny and reflective ornaments appeals to the cats' instincts and draws cats to the Christmas tree. Further, the structure of the Christmas tree provides an enticing climbing challenge and appeals to the cat's instinct to explore different heights.

Further, real Christmas trees introduce new scents and textures into the home. The pine or fir smell is intriguing, which prompts cats to sniff, rub, and sometimes chew on the branches. As a result, ornaments are knocked over and broken, and lights are chewed, which poses a risk of electrocution. Sometimes, the tree itself is toppled, which leads to a mess and potential damage to furniture and other household items. Some cats are also attracted to the taste and smell of the tree materials, including real or artificial tree materials, which leads the cats to chew on the branches or needles. Thus, the features of the Christmas tree require the cat owners to constantly monitor their cats and keep the cats away from the tree, which could be exhausting and diminish the joy of Christmas celebrations.

Additionally, dismantling and storing artificial trees after the holiday season can be cumbersome, as the tree parts may be heavy and difficult to fit into containers or cartons without risking damage. Further, the cats might destroy the Christmas tree by trying to reach the ornaments that are present on the Christmas tree.

U.S. Pat. No. 6,458,435 assigned to Jimmy Kam-Wing Lai, entitled “Artificial tree” discloses an artificial tree having a central trunk, a number of main branches suspended from an upper portion of the trunk in a downwardly and outwardly inclined orientation, and a preformed tree top section extending upwardly from the upper portion of the trunk. Each main branch includes a number of sub-branch clusters and a bundle of fiber optic conduits which terminate in the sub-branches. The bundles of Fiber optic conduits are received in an opaque enclosure housing a high intensity light source, which enclosure is attached to the upper portion of the trunk. Electric lights are disclosed as an alternative means to illuminate the tree. The trunk includes upwardly open hook elements which receive pin elements within the interior of rigid support members of the main branches. Each sub-branch cluster is pivotally connected to an associated rigid support member to articulate between a collapsed position for storage and shipping, and an extended position for display.

U.S. Pat. No. 6,116,563 assigned to Yuan-Hui Tsai, entitled “Christmas tree with improved branch joint” discloses a branch joint for use with a christmas tree to connect a plurality of additional branches to trunk of the christmas tree, are designed to an umbrella-shaped body. A plurality of top and bottom ellipses respectively distributed on the top and bottom circumference of said body. A plurality of recesses form on a top edge of said body. Meanwhile, the additional branches are capable of being respectively inserted into said top ellipses, through the bottom ellipses, to be inward bent at a specific angle then for retaining a distal end of each branch within the corresponding recess whereby the branches and the umbrella-shaped body are retained together in a more natural, simple and useful manner. However, existing prior art fails to provide a structure or design that accommodates feline behavior or mitigates the risk of cats damaging tree decorations or the Christmas tree.

Therefore, there is a need for an artificial Christmas Tree that enables cats to engage in play without damaging the Christmas tree and addresses the challenges faced by the pet owners.

### SUMMARY

The present invention discloses an artificial Christmas tree integrated with a cat tower. The tree comprises a base and a trunk disposed above the base. The trunk is formed of a plurality of hollow members. The hollow members collectively define a pathway therethrough. The pathway may extend uninterrupted from the base to one or more platforms and also between two platforms disposed at different heights within or along the trunk. In some embodiments, the hollow members define a continuous pathway therethrough, such that the pathway extends uninterrupted from the base to one or more platforms and also between two platforms disposed within or along the trunk. In various embodiments, the artificial Christmas tree may be configured to be stackable.

In some embodiments, the continuous pathway defined by the plurality of hollow members may extend uninterrupted from the base to a top platform, allowing an animal such as a cat to ascend entirely within the trunk without exiting. In alternative embodiments, the pathway may include one or more interrupted or segmented sections, such that there is no direct internal connection between every adjacent level or between the base and the first level. For example, the base may include an entry point that leads to an internal hollow member terminating at a first enclosed platform. A cat may then exit onto the first platform and subsequently access a second hollow segment leading to a higher platform. In such cases, the hollow trunk still facilitates vertical travel between platforms via a combination of internal and external traversal, and such configurations are within the scope of the present invention.

The plurality of hollow members comprises a first hollow member, a second hollow member, and a plurality of intermediate hollow members disposed between the first hollow member and the second hollow member. In one embodiment, the first hollow member and the intermediate hollow members comprise a cylindrical configuration, and the second hollow member comprises a substantially conical configuration. The Christmas tree further comprises a first lock assembly configured to lock the hollow members to one another.

The cat tower further comprises one or more platforms disposed at the trunk. In one embodiment, at least one platform is disposed within one or more hollow members. Further, at least one opening defined at one or more hollow members connected to the pathway. The pathway is dimensioned to allow at least one animal to maneuver therethrough. The platforms are arranged to serve as steps to facilitate movement of at least one animal, for example, cat, through the continuous pathway. In some embodiments, the platform such as a flat surface, hammock, or other support structure may be detachable or retrofittable, allowing flexibility in installation, customization, or maintenance. The Christmas tree further comprises a decorative assembly configured to simulate at least one of the natural foliage, branches, and ornamental structures.

In another embodiment, at least one platform is disposed within each hollow member. In one embodiment, at least one platform is disposed adjacent to the opening. In one embodiment, each platform comprises a base portion, a first extended portion extending from the base portion and a second extended portion extends from a portion of an edge of the first extended portion. Further, the second extended portion extends perpendicular to the first extended portion. The base portion extends from at least a portion of an interior surface of the hollow member and the first extended portion extends beyond the hollow member through the opening.

In one embodiment, the decorative assembly comprises a first branch assembly. In one embodiment, the first branch assembly comprises a first support member and one or more branch members extending from the first support member. The branch member comprises a plurality of needles. The first branch assembly is locked to the trunk via a second lock assembly.

The second lock assembly comprises one or more first bracket members. The first bracket member comprises an elongated base member, one or more ridges extend along a length of the base member, and one or more hook members disposed at one end of the base member configured to hook onto the hollow member. In one embodiment, the first support member complementary to the first bracket member is configured to lock the first branch assembly with the second lock assembly.

In one embodiment, at least one platform is disposed on the exterior surface of the hollow member. The platform further comprises a second bracket member configured to lock to at least one of the trunk and the first bracket member.

In another embodiment, the decorative assembly comprises a branch assembly attached to the trunk using a hinged system. The branch assembly automatically slide into designated place and fan out to form a spruce shape. In yet another embodiment, the decorative assembly comprises a second branch assembly comprising a second support member and one or more branch members extending from the second support member. The branch member comprises a plurality of needles. A distal end of the second support member comprises a bent portion. The distal end is inserted through an opening in the trunk such that the bent portion engages with a pair of grooves, which may, in some embodiments, comprise open recesses or hollow channel-like structures, disposed along an interior or exterior surface of the trunk, thereby securing the support member in position.

In yet another embodiment, the decorative assembly comprises a third branch assembly comprising a third support member and one or more branch members extending from the third support member. The third support member comprises at least one of circular configuration and curved configuration.

In yet another embodiment, the decorative assembly comprises a covering assembly comprising a plurality of panels arranged concentrically and vertically spaced apart to form a substantially tapered structure simulating a shape of a tree, and at least one pole extending from a central portion of a first panel of the plurality of panels. The pole is configured for insertion into a corresponding aperture at a top portion of the trunk. Each panel comprises one or more opening portions to allow access to portions of the trunk, and the panels are configured to be collapsed into a compact arrangement and unfolded into a tree-like structure. In some aspects, the decorative assembly comprises one or more branch assemblies that are removably attachable to the trunk using a bracket, hanger, or locking mechanism, wherein the trunk and platform assembly is configured for standalone use as a cat tower outside of seasonal use, and wherein the branch assemblies are stored separately when not in use.

In yet another embodiment, the artificial Christmas tree comprises a base, at least one pole disposed above the base, one or more platforms are arranged at different places on the pole, and one or more branch assembly arranged to extend from at least one of the pole and the platform. The branches are arranged to form a pathway connecting the platforms. The pathway is dimensioned to allow at least one animal to maneuver therethrough. The platforms are arranged to serve as steps to facilitate the movement of at least one animal, such as a cat, through the continuous pathway.

The inclusion of a “pathway” is critical to the novelty of the invention. While the use of hollow trunk members and platform features may not, by themselves, distinguish the invention from prior art artificial trees (which may use hollow components for structural or decorative purposes), the introduction of a “pathway” that extends through and between these features provides a novel and functionally significant improvement. In essence, the “pathway” introduces an internal traversal architecture, not merely hollow space for wire-routing or mounting purposes, but a defined, interconnected spatial structure that enables movement (e.g., for a pet like a cat) or access between platforms and from the base upward. This goes beyond traditional construction and introduces a new functional paradigm. This pathway concept integrates the trunk, hollow members, and platforms into a unified system that supports novel use cases (e.g., interactive pet use, internal illumination routing, internal branch deployment mechanisms, or modular decorations). Simply stating that there is a hollow member does not convey this system-level integration and would not cover embodiments where the pathway extends beyond a single hollow member.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates a perspective view of an artificial Christmas tree integrated with a cat tower, according to an embodiment of the present invention.

FIG. 2 exemplarily illustrates a front view of the artificial Christmas tree integrated with the cat tower, according to an embodiment of the present invention.

FIG. 3 exemplarily illustrates a perspective view of the cat tower, according to an embodiment of the present invention.

FIG. 4 exemplarily illustrates a front view of the cat tower, according to an embodiment of the present invention.

FIG. 5 exemplarily illustrates an exploded view of the cat tower, according to an embodiment of the present invention.

FIG. 6 exemplarily illustrates a perspective view of an artificial Christmas tree, according to another embodiment of the present invention.

FIG. 7 exemplarily illustrates a perspective view of a branch assembly fixed to the Christmas tree, according to an embodiment of the present invention.

FIG. 8 exemplarily illustrates a branch assembly of the artificial Christmas tree, according to an embodiment of the present invention.

FIG. 9 exemplarily illustrates a top view of an artificial Christmas tree integrated with a cat tower, according to yet another embodiment of the present invention.

FIG. 10 exemplarily illustrates an artificial Christmas tree integrated with a cat tower, according to yet another embodiment of the present invention.

FIG. 11 exemplarily illustrates a first branch assembly of FIG. 10, according to an embodiment of the present invention.

FIG. 12 exemplarily illustrates a trunk with a second locking assembly, according to an embodiment of the present invention.

FIG. 13 exemplarily illustrates the second locking assembly hooked to the trunk, according to an embodiment of the present invention.

FIG. 14A exemplarily illustrates a platform connected to the trunk, according to an embodiment of the present invention.

FIG. 14B exemplarily illustrates a hinged branches connected to the trunk, according to an embodiment of the present invention.

FIG. 14C exemplarily illustrates the hinged branches connected to the trunk using dual-rivet system, according to an embodiment of the present invention.

FIG. 15 exemplarily illustrates an artificial Christmas tree integrated with a cat tower, according to yet another embodiment of the present invention.

FIG. 16 exemplarily illustrates a first decorative covering assembly, according to an embodiment of the present invention.

FIG. 17 exemplarily illustrates the first covering assembly of FIG. 16 in collapsed configuration, according to an embodiment of the present invention.

FIG. 18 exemplarily illustrates a cross-sectional view of an artificial Christmas tree integrated with a cat tower, according to yet another embodiment of the present invention.

FIG. 19 exemplarily illustrates a second covering assembly being fixed over the trunk of the tree of FIG. 18, according to an embodiment of the present invention.

FIG. 20 exemplarily illustrates a perspective view of the second covering assembly, according to an embodiment of the present invention.

FIG. 21 exemplarily illustrates a perspective view of a second branch assembly mounted to a vertically segmented trunk structure comprising multiple support panels with integrated grooves for branch attachment, according to an embodiment of the present invention.

FIG. 22 exemplarily illustrates an artificial Christmas tree integrated with a cat tower, according to yet another embodiment of the present invention.

FIG. 23 exemplarily illustrates a perspective view of the cat tower, according to an embodiment of the present invention.

FIG. 24 exemplarily illustrates a perspective view of a third branch assembly, according to an embodiment of the present invention.

FIG. 25 exemplarily illustrates a perspective view of a third support member, according to an embodiment of the present invention.

FIG. 26 exemplarily illustrates an artificial Christmas tree integrated with a cat tower, according to yet another embodiment of the present invention.

FIG. 27 exemplarily illustrates an interior surface of the hollow member comprising the platform, according to an embodiment of the present invention.

### DETAILED DESCRIPTION OF EXAMPLE EMBODIMENTS

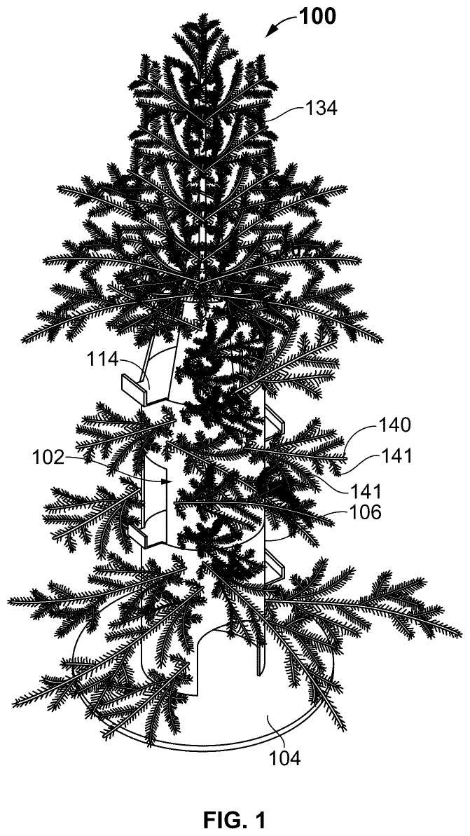

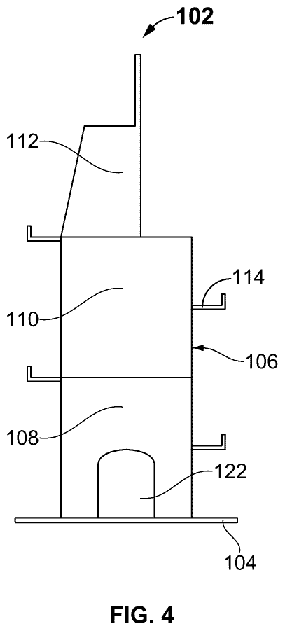

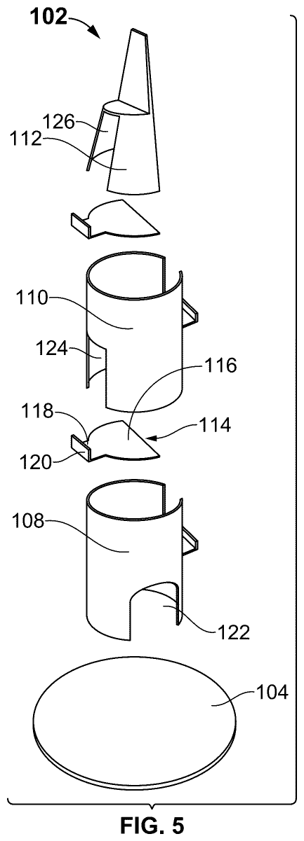

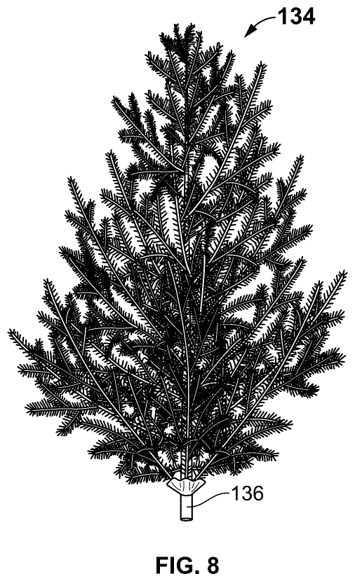

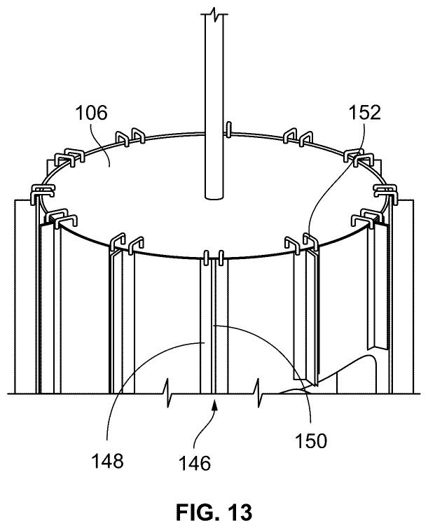

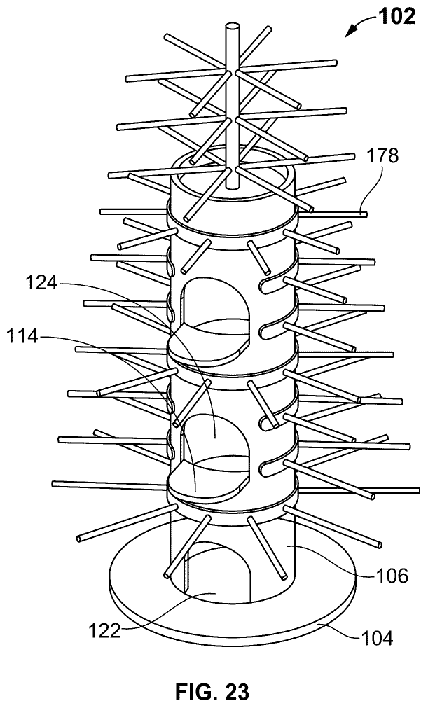

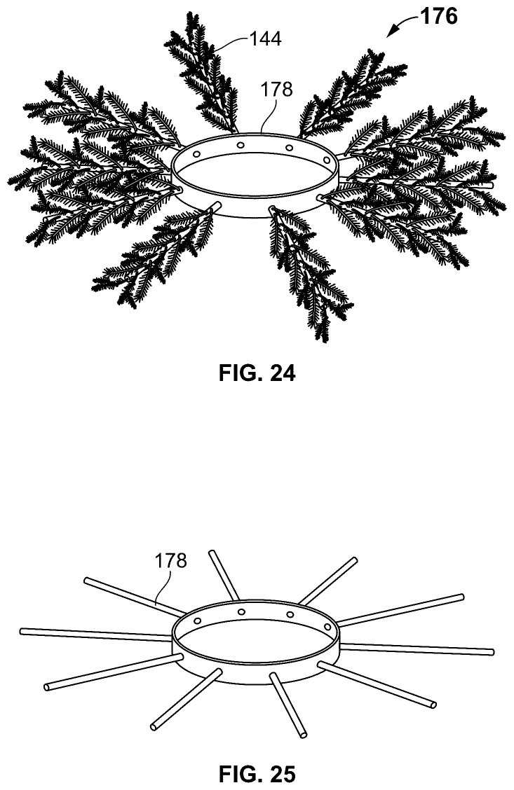

Referring to FIG. 1 to FIG. 27, an artificial Christmas tree (100, 200, 400, 500, 600, 700, 800) integrated with a cat tower 102 comprises a base 104 and a trunk 106 disposed above the base 104. The trunk 106 is formed of a plurality of hollow members. The plurality of hollow members comprises a first hollow member 108, a second hollow member 112 and a plurality of intermediate hollow members 110 disposed between the first hollow member 108 and the second hollow member 112. The artificial Christmas tree 100 also referred as tree 100 throughout this document. In various embodiments, the artificial Christmas tree 100 may be configured to be stackable.

The cat tower 102 further comprises one or more platforms 114. At least one platform 114 is disposed within each hollow member (108, 110, 112). Each platform 114 comprises a base portion 116, and a first extended portion 118 extending from the base portion 116. The first extended portion 118 and the base portion 116 lie in a same plane. Further, a second extended portion 120 extends from a portion of an edge of the first extended portion 118. The second extended portion 120 extends perpendicular to the first extended portion 118. The platform 114 provides a space for the cats to play or rest. The second extended portion 120 is configured to deters the cat from jumping off the platform 114. In some embodiments, the platform 114 may be detachable or retrofittable, allowing flexibility in installation, customization, or maintenance.

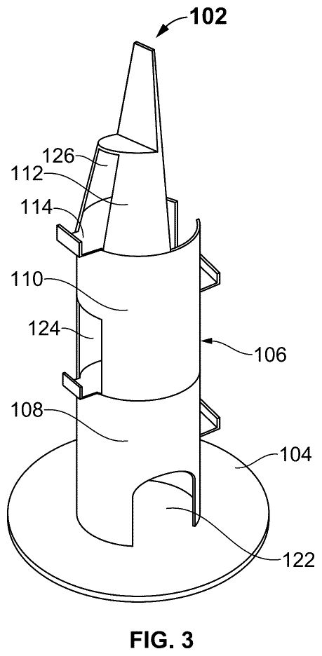

Referring to FIG. 3 to FIG. 27, each hollow member (108, 110, 112) comprises at least one opening (122, 124, 126) and at least one platform 114 disposed adjacent to the opening (122, 124, 126). The base portion 116 extends from at least a portion of an interior surface of the hollow member (108, 110, 112) and the first extended portion 118 extends beyond the hollow member (108, 110,112) through the opening (122, 124, 126). Further, the second extended portion 120 extends perpendicular to the first extended portion 118. The cat tower 102 further comprises a pathway defined through the plurality of hollow members (108, 110, 112).

The first hollow member 108 is disposed above the base 104, the intermediate hollow members 110 are disposed above the first hollow member 108, and the second hollow member 112 is disposed above the intermediate hollow member 110. In one embodiment, the first hollow member 108 and the intermediate hollow members 110 comprises a cylindrical configuration, and the second hollow member 112 comprises a substantially conical configuration. The hollow members (108, 110, 112) could have any other type of suitable configuration. The hollow members (108, 110, 112) are stacked one above another to form the trunk 106.

The first hollow member 108 comprises a first opening 122 at a base portion of the first hollow member 108. The first hollow member 108 further comprises at least one intermediate opening 124 that connects the first opening 122 and the pathway defined in the cat tower 102.

Further, each intermediate hollow member 110 comprises one or more intermediate openings 124. The intermediate openings 124 of the intermediate hollow members 110 are connected to the first opening 122 and the pathway defined in the cat tower 102. The first opening 122 enables the cats to enter the pathway. Further, the second hollow member 112 comprises a second opening 126 and at least one intermediate opening 124. The second opening 126 is connected to the intermediate openings 124, the first opening 122, and the pathway defined in the cat tower 102. The tree 100 further comprises a first lock assembly configured to lock the hollow members (108, 110, 112) to one another. The pathway enables the cats to climb at different height levels of the tree 100 using the platform 114. Further, the pathway 114 enables the cat to play and rest within the cat tower 102 and interact with the artificial Christmas tree 100, thereby avoiding damage to the gifts, furniture, carpets, and like. In some embodiments, the hollow members (108, 110, 112) define a continuous pathway therethrough, such that the pathway extends uninterrupted from the base 104 to one or more platforms (108, 110, 112) also between any at least two platforms disposed within or along the trunk 106. The opening (122, 124, 126) could be decorated to attract the cat, for example, similar to a gift box.

The first opening 122, the second opening 126 and the intermediate opening 124 are generally referred as opening (122, 124, 126) throughout this document. The first hollow member 108, the second hollow member 112 and the intermediate hollow members 110 are also referred as hollow members (108, 110, 112) throughout this document.

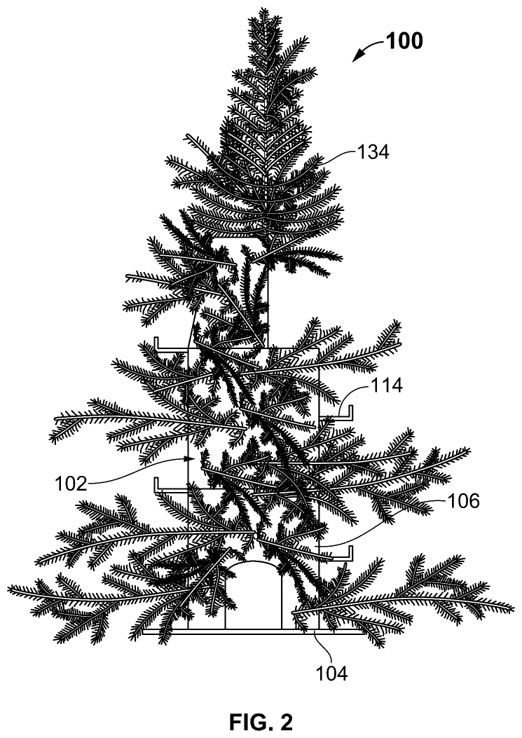

Referring to FIG. 1 and FIG. 2, the tree 100 further comprises one or more branches or branch members 144 configured on the trunk 106 of the tree 100. The branches comprise a plurality of needles 141. The tree 100 further comprises top branches 144 to project above the top of the trunk 106 for the top of the tree 100. The tree 100 further comprises a second lock assembly configured to lock the branches 144 to the trunk 106.

In one embodiment, the second lock assembly comprises a first mounting bracket disposed on the trunk 106. In one embodiment, the first mounting bracket is a female mounting bracket and a proximal end of the branch is coupled to the mounting bracket. The end of the branch comprises a 90-degree bend portion. The bend portion is inserted into a slot of the first mounting bracket. The first mounting brackets have slots to prevent rotation or movement of the branch in all directions. Further, the branches are removed by a user by lifting the branches vertically out of the first mounting bracket.

In another embodiment, the second lock assembly comprises a second mounting bracket and the proximal end of the branch is pivotally connected to the second mounting bracket. The second lock assembly comprises a hinge mechanism that enables the branches to fold upwards and inwards towards the trunk 106 for compact seasonal storage, and to extend downwards and outwards for assembly into a tree form. The trunk 106 of the tree 100 with hinged branches is typically segmented into multiple sections, facilitating adequate space for the branches to fold upwards during storage and be manageable for a user to operate.

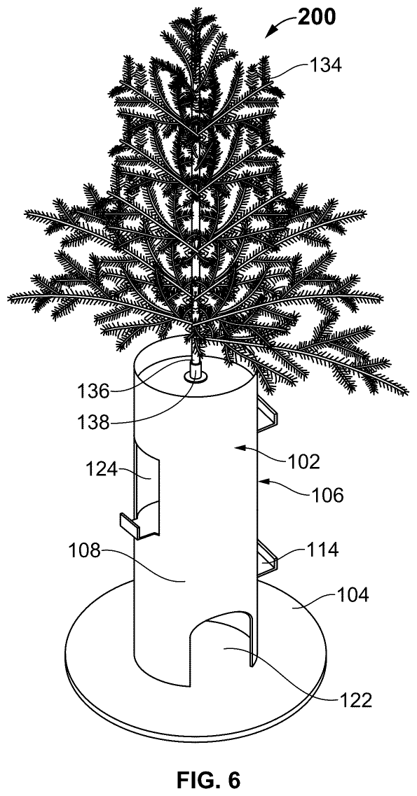

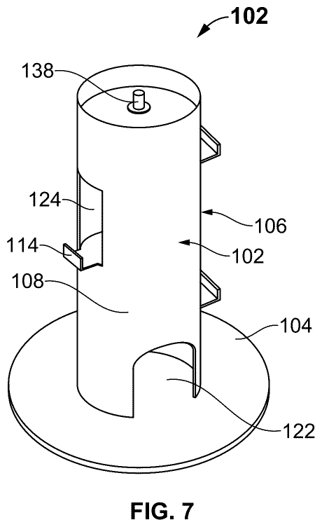

Referring to FIG. 6 and FIG. 7, an artificial Christmas tree 200 integrated with the cat tower 102 comprises the base 104 and the trunk 106 disposed above the base 104. The trunk 106 comprises at least one hollow member (108, 110, 112). The hollow member (108, 110, 112) comprises one or more openings (122, 124, 126) and one or more platforms 114 adjacent to one or more openings (122, 124, 126). The hollow member (108, 110, 112) comprises at least one pathway connecting the openings (122, 124, 126). In some embodiments, the hollow members (108, 110, 112) define a continuous pathway therethrough, such that the pathway extends uninterrupted from the base 104 to one or more platforms (108, 110, 112) disposed within or along the trunk 106.

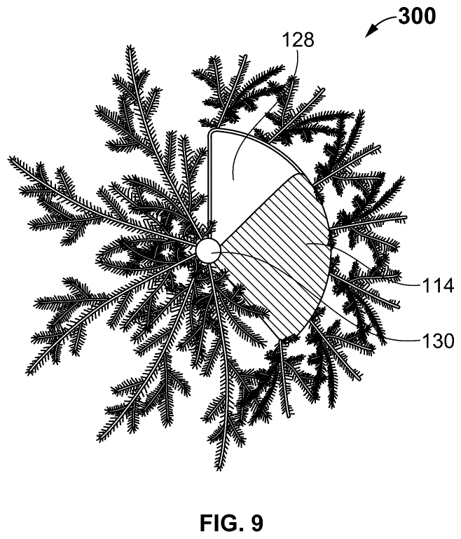

Referring to FIG. 9, an artificial Christmas tree 300 comprises the base 104, a pole 130 and one or more platforms 114 arranged at different places on the pole 130. The tree 300 further comprises branches extending from suitable location of at least one the pole 130 and the platform 114. The branches are arranged such that the tree 300 provides an open portion 128 to allow the pets to climb onto the platforms 114 and move between the platforms 114. The artificial Christmas tree 300 further comprises one or more hollow portions at the open portions 128. The hollow portions are suspended to form a pathway connecting the platforms 114.

Referring to FIG. 1 to FIG. 9, in one embodiment, cat tower 102 is typically constructed of wood, composite, or plastic for the main structure and covered in a material such as carpet or rope, which cats enjoy rubbing and scratching. The cat tower 102 could be made of any other suitable material and dimensions. Referring to FIG. 6 to FIG. 9, the tree (200, 300) further comprises one or more branches configured on the trunk 106 of the tree 100. The branches comprise a plurality of needles 141. The tree (200, 300) further comprises a second lock assembly configured to lock the branches to the trunk 106, which is same as that of the embodiment of the tree 100. Thus, reference shall be made to the embodiment of the tree 100 for understanding the mentioned components.

Referring to FIG. 1 to FIG. 9, the artificial Christmas tree (100, 200, 300) comprises a branch assembly 134 comprising a center pole 136. The artificial Christmas tree (100, 200, 300) further comprises a pole connector 138 disposed at a top portion of the cat tower 102. The branch assembly 134 is affixed at a top portion of the cat tower 102 by fastening the center pole 136 to the pole connector 138. The tree (100, 200, 300) further comprises one or more ornaments disposed proximal to the platform 114 that enable the pets to play with the ornaments without damaging the tree (100, 200, 300). The ornaments are cat friendly ornaments. The ornaments, includes, but not limited to, catnip ornaments and toy ornaments.

In another embodiment, the tree (100, 200, 300, 400, 500, 600, 700, 800) further comprises a light assembly, a power source assembly connected to the light assembly, and a circuit configured on the tree (100, 200, 300, 400, 500, 600, 700, 800) connecting the light assembly and the power source assembly. In one embodiment, the light assembly comprises a plurality of built-in light emitting diodes (LED). In one embodiment, the circuit runs within at least one of the trunk 106 and the branches. In another embodiment, the circuit disposed externally to the trunk 106 and the branches. In yet another embodiment, the circuit disposed to run at least partially internal and at least partially external to the trunk 106 and the branches. In one embodiment, the power source assembly comprises one or more batteries. In one embodiment, the battery is a rechargeable battery.

In one embodiment, the tree (100, 200, 300, 400, 500, 600, 700, 800) further comprises electrical outlets to connect to an external source to supply power to the light assembly. The tree (100, 200, 300, 400, 500, 600, 700, 800) could be plug-in with an ac-to-dc converter. Further, one or more components of the artificial Christmas tree (100, 200, 300, 400, 500, 600, 700, 800) could be integrated with each other to form a single unit. For example, the base 104 could be integrated with the trunk 106. This integration enhances the structural stability and ease of assembly of the tree (100, 200, 300, 400, 500, 600, 700, 800).

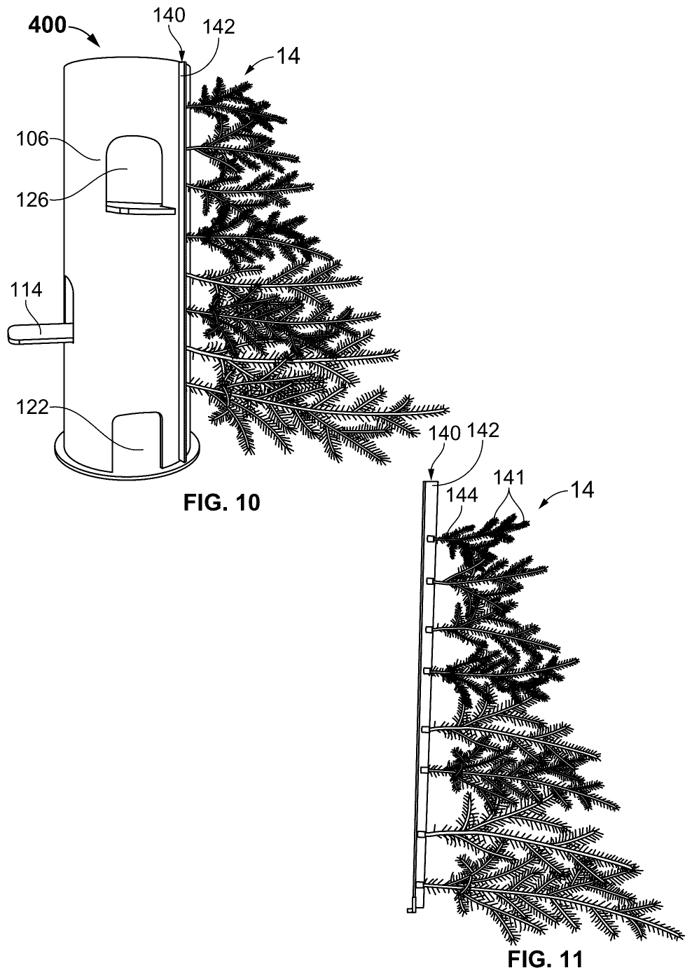

Referring to FIG. 10 and FIG. 11, in one embodiment, a tree 400 comprises a first branch assembly 140. The first branch assembly 140 comprises a first support member 142 and one or more branch members 144 extending from the first support member 142. Each branch member 144 comprises a plurality of needles 141 to simulate the appearance of natural tree foliage. Although only one first branch assembly 140 is illustrated in FIG. 10 as attached to the trunk 106, it should be understood that multiple branch assemblies may be affixed around the trunk 106 to form a complete tree structure.

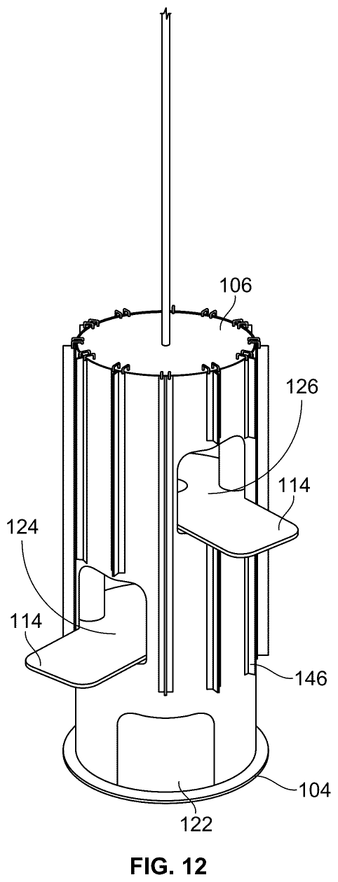

Referring to FIG. 12 to FIG. 14, the first branch assembly 140 is locked to the trunk 106 via a second lock assembly. In yet another embodiment, the second lock assembly comprises one or more first bracket members 146. The first bracket member 146 comprises an elongated base member 148, one or more ridges 150 extends along a length of the base member 148, and one or more hook members 152 disposed at one end of the base member 148. The hook members 152 are configured to engage or hook onto a corresponding edge or feature of the hollow member (108, 110, 112) to facilitate attachment. The first support member 142 is complementary in geometry to the first bracket member 146 and is configured to lock the first branch assembly 140 to the trunk 106 via the second lock assembly.

In one embodiment, the branch members 144 are configured to pivot upward for compact seasonal storage, and then fan outward during deployment. In another configuration, non-hinged branch assemblies may also be utilized.

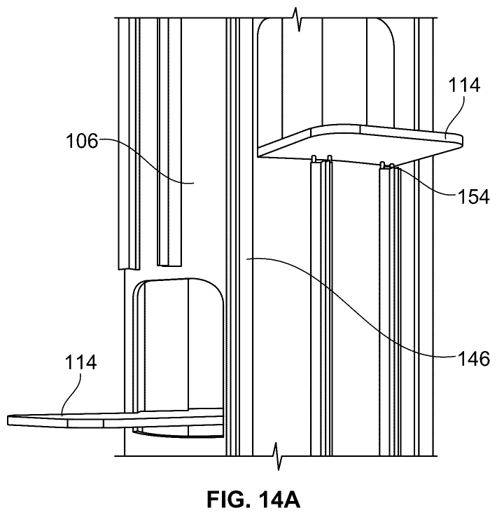

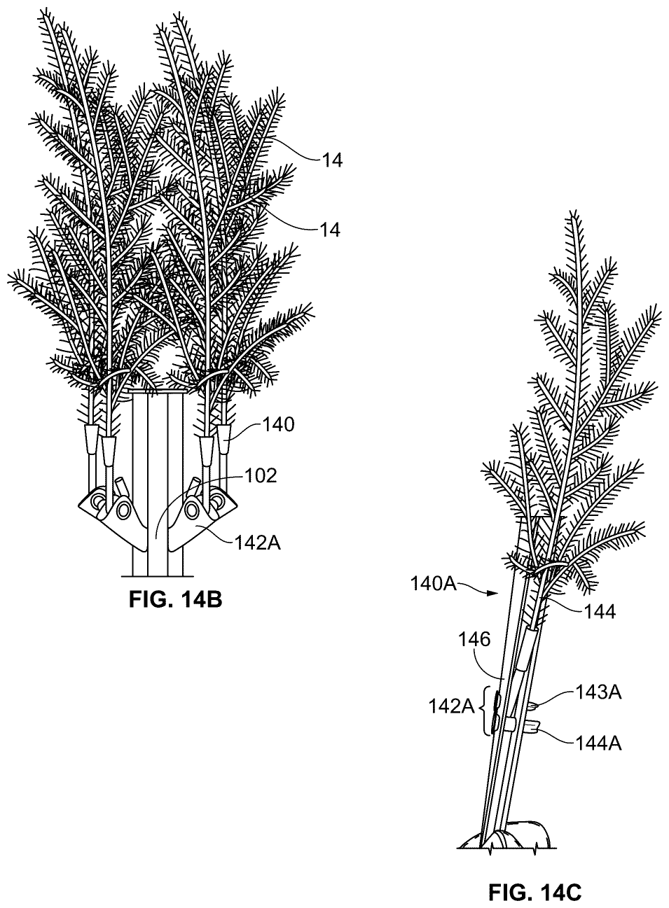

Referring to FIG. 14A, at least one platform 114 is disposed on exterior surface of the hollow member (108, 110, 112). The platform 114 further comprises a second bracket member 154, which, in some embodiments, may resemble a hanging branch, configured to lock to at least one of the trunk 106 and the first bracket member 146.

In some embodiments, the tree 400 may be provided as a fully integrated unit, in which the second lock assembly and hinged, first branch assembly 140 are pre-assembled and secured to a multi-segment vertical body, forming the central trunk 106 or cat tower 102. Such an integrated configuration may be designed for seasonal use only, in contrast to convertible, year-round cat tower configurations that allow for branch removal.

Furthermore, as illustrated in FIG. 14B-14C, the hinged connection for the branch assemblies or hinged branches 140A may utilize a dual-rivet system 142A including a first rivet or a pivot rivet 143A providing a pivoting function and a second rivet or stop rivet 144A acts as a rotation stop, thereby preventing the branch members 144 from over-rotating beyond a defined deployment position. As illustrated in FIG. 14B-14C, the dual-rivet hinge or dual-rivet system 142A allows rotation of the hook from a stored horizontal to a deployed vertical position, where rotation is physically limited by the stop rivet 144A.

In some embodiments, the second rivet 144A is positioned below the pivot rivet 143A such that when the hanger arm or first bracket member 146 is unfolded into its vertical orientation, the inner edge of the arm comes into contact with the second rivet 144A, thereby halting further downward rotation. The structural profile of the hanger or first bracket member 146 is shaped to accommodate the rotational clearance of the hook arm or second bracket member 154, while enabling the second rivet 144A to act as a reliable physical stop.

In another embodiment, the decorative assembly 14 comprises a first branch assembly 140 attached to the trunk 102 using a hinged system 142A. The first branch assembly 140 is configured to automatically slide into designated place and fan out to form a spruce shape.

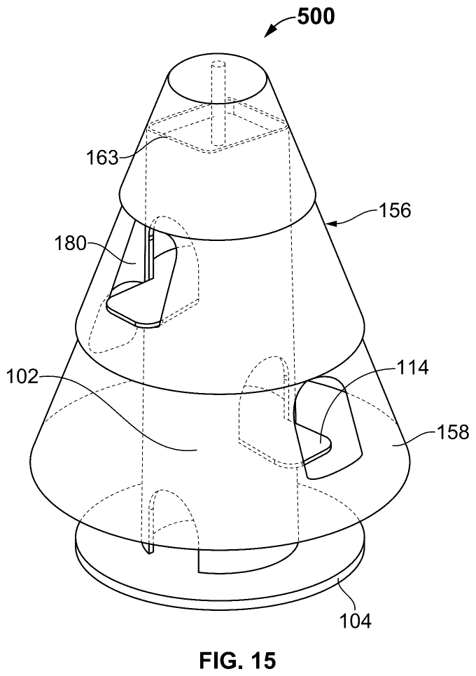

Referring to FIG. 15 to FIG. 17, an artificial Christmas tree 500 comprises a first decorative covering assembly or first covering assembly 156. The decorative covering assembly 156 is shown in its fully expanded and installed state, mounted over or surrounding the trunk 106. The first decorative covering assembly 156 comprises mesh layers 158 that are expanded to form a stepped, tree-like profile.

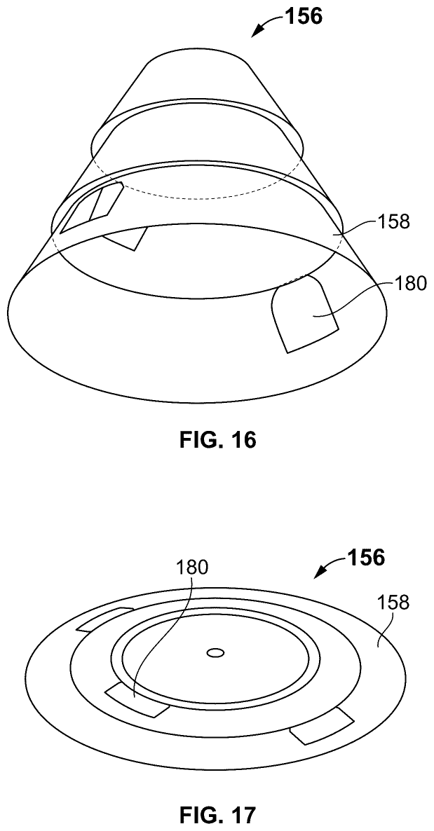

Referring to FIG. 17, the first covering assembly 156 is shown in a fully collapsed or flattened configuration. In this state, the first covering assembly 156 occupies minimal vertical space and is suitable for compact storage or transport.

The mesh layers 158 comprises opening portions 180 corresponding to the openings (122, 124, 126) in the cat tower 102.

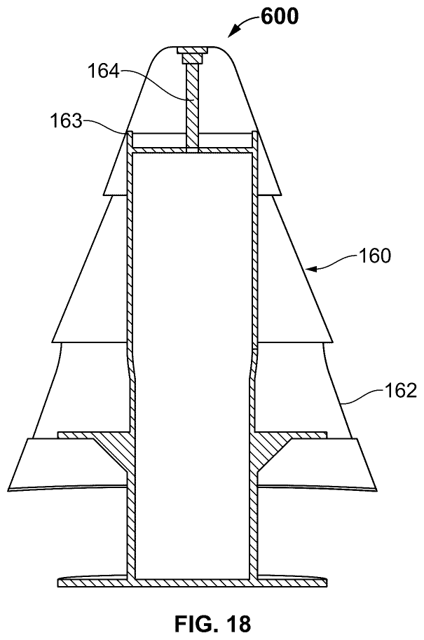

Referring to FIG. 18 to FIG. 20, an artificial Christmas tree 600 comprises a second decorative covering assembly or second covering assembly 160. The second covering assembly 160 is shown in its fully expanded and installed state, mounted over or surrounding the trunk 106. The second decorative covering assembly 160 comprises panels 162 that are expanded to form a stepped, tree-like profile. In alternative embodiments, the umbrella structure or artificial Christmas tree (500/600) at FIGS. 15-18 may be mounted without a central support pole or central stick or rod 164. In such cases, the umbrella components (e.g., 156, 158, 160, 162) may be configured to rest atop and interlock with the uppermost portion of the tower structure 102 via a mating geometry structure 163 such as a recessed seat, interlocking flange, or friction-fit socket. In other words, FIGS. 15-18 could be assembled without a pole at top as well, where the umbrella structure just sits on top of, and mates via a mating geometry structure 163 with the top of the tower.

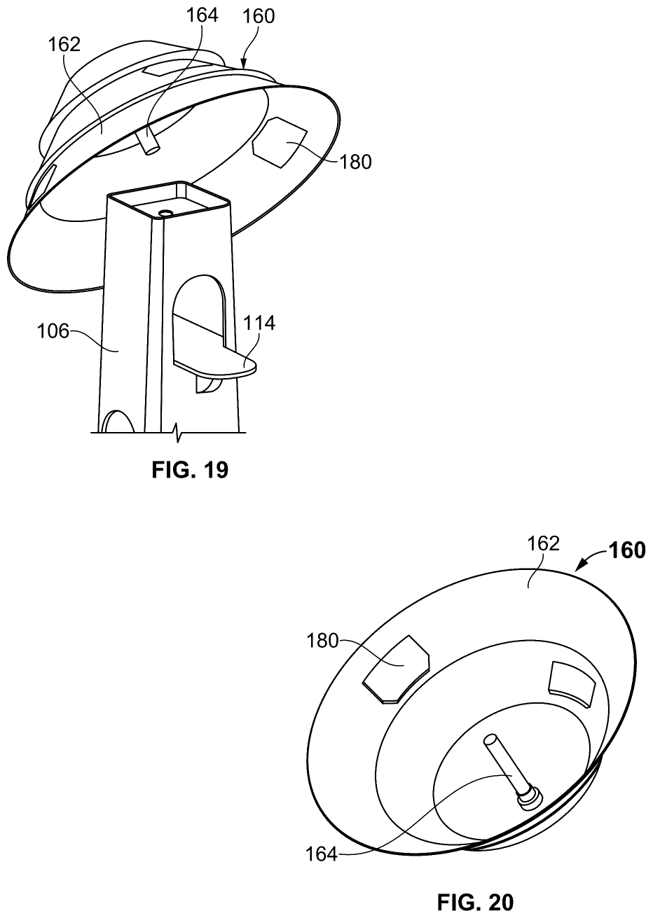

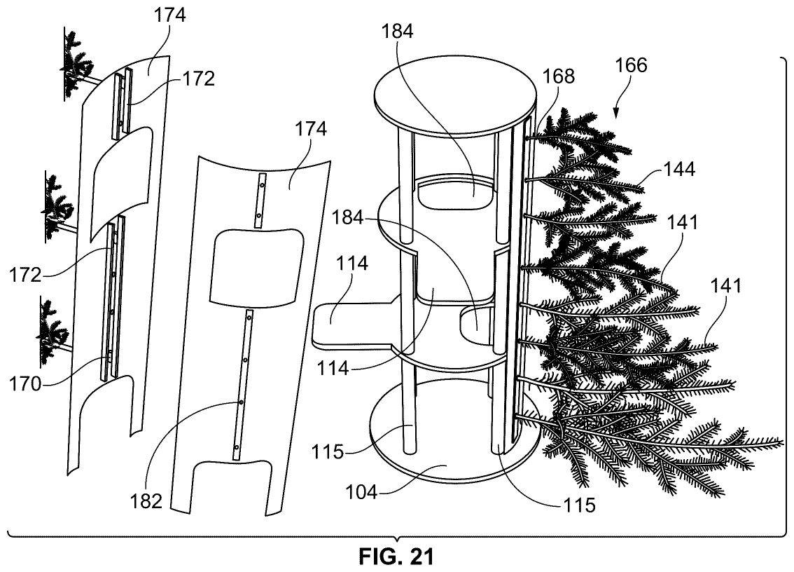

Referring to FIG. 19 and FIG. 20, the panels 162 are concentrically arranged, and a central stick or rod 164 extends downward. The rod 164 functions as a mounting element that is inserted into a corresponding hole at the top of the vertical trunk 106, enabling secure attachment of the panels 162. Referring to FIG. 21, the decorative assembly 14 includes a second branch assembly 166 comprising a second support member 168 and one or more branch members 144 extending from the second support member 168. Each branch member 144 comprises a plurality of needles 141. Additionally, one or more platforms 114 are arranged vertically, one above the other, supported by a vertical pole 115 connected to the base 104. FIG. 21 exemplarily illustrates a perspective view of the second branch assembly 166 mounted to a vertically segmented trunk structure composed of multiple support panels 174, each incorporating integrated grooves 172 for branch attachment, in accordance with an embodiment of the present invention. The segmented trunk structure forms part of a large body, typically composed of between two and eight vertical panels 174 extending the full height of the decorative assembly 14 or cat tower. These vertical panels 174 include grooves or channels 172 running along their length, configured to receive and support the branch members or branch assemblies 144. In certain seasonal implementations, such as when the unit functions solely as a decorative item (e.g., a Christmas tree) and does not convert into a standard cat tower for year-round use, the branch members 144 may be permanently affixed within the grooves 172. In such configurations, the branches may be hinged and secured between plastic grooves using fasteners, such as rivets, enabling folding, unfolding, or fixed orientations depending on the intended functionality. A pathway 184 is formed within the vertically segmented trunk structure to allow a cat to navigate among the different platforms 114. FIG. 21 further accommodates configurations in which the trunk or tower body is divided into four vertical sections. This modular design facilitates simplified assembly and storage while maintaining structural integrity and alignment for both decorative and functional purposes.

Further, a distal end of the second support member 168 comprises a bent portion 170. The distal end is inserted through an aperture in the trunk such that the bent portion 170 engages with a pair of grooves 172 disposed along a surface 174 of the trunk 106, thereby securing the second support member 168 in position.

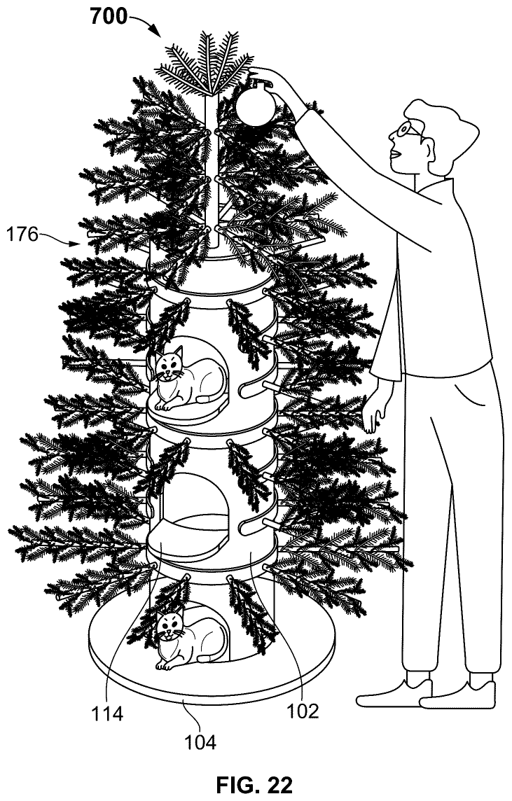

Referring to FIG. 22 to FIG. 25, an artificial Christmas tree 700 comprises a third branch assembly 176 comprises a third support member 178 and one or more branch members 144 extending from the third support member 178. The third support member 178 comprises at least one of circular configuration and curved configuration. The branch members 144 may be attached to the support member 178 by one or more of the following methods: compression (e.g., flexible snap compression or fixed wrap and compression by a tapered trunk), fasteners (e.g., screws), or brackets.

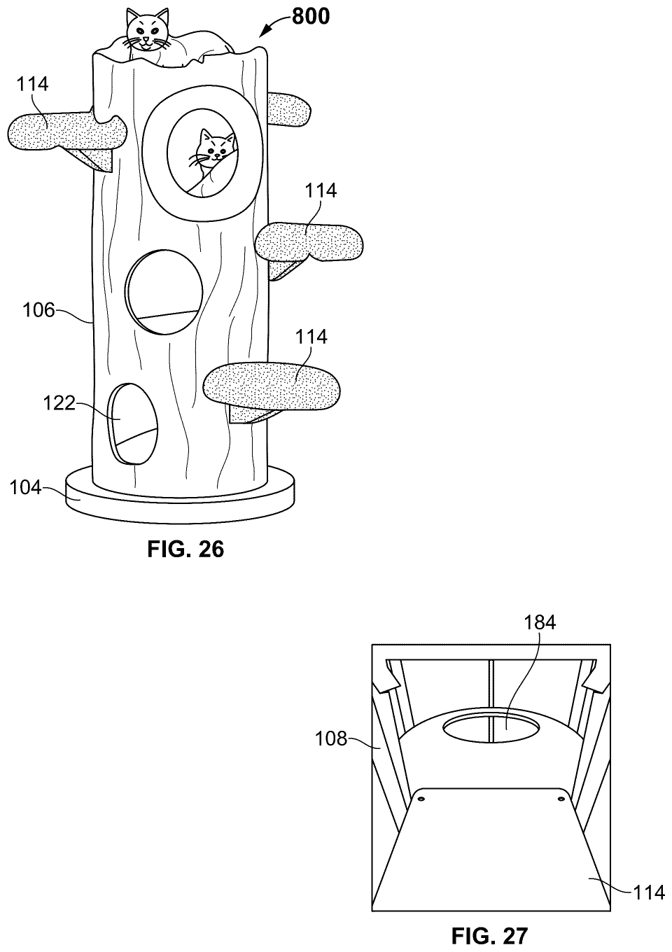

Referring to FIG. 26, an artificial Christmas tree 800 comprising one or more platforms 114 attached to the trunk 106. Referring to FIGS. 27 & 21, a pathway, referred as 184, formed within the hollow member (108, 110, 112) enables cat to navigate to different platforms 114.

The Artificial Christmas tree (100, 200, 300, 400, 500, 600, 700, 800) provides consumers an option for a holiday decoration that is reusable, with seasonal storage, and prevents the mess and hassle associated with a natural tree. Further, the cat tower 102 integrated with the tree (100, 200, 300, 400, 500, 600, 700, 800) provides a structure where cats could play and rest in, providing pet owners relief from damage to upholstery, furniture, curtains, etc. In certain embodiments, the artificial Christmas Tree (100, 200, 300, 400, 500, 600, 700, 800) could be transformed into a year-round cat tower 102 for continued use, thus solving the issue of space required to store artificial Christmas trees (100, 200, 300, 400, 500, 600, 700, 800) between their seasonal use. This transformation may include a fully integrated cat tower structure, such as in FIG. 21, where branches are permanently attached and can be hinged for folding or compact storage, while still providing functional use as a cat tower.

Advantageously, the present invention facilitates the easy dismantling and storage of the artificial Christmas tree (100, 200, 300, 400, 500, 600, 700, 800). Additionally, the artificial Christmas tree (100, 200, 300, 400, 500, 600, 700, 800) integrated with the cat tower 102 allows cats to play on and within the tree (100, 200, 300, 400, 500, 600, 700, 800), thereby promoting interaction and engagement with pets. Furthermore, the present invention provides a means for users and pet owners to relax and enjoy the artificial Christmas tree (100, 200, 300, 400, 500, 600, 700, 800), enhancing the overall holiday experience. The artificial Christmas tree (100, 200, 300, 400, 500, 600, 700, 800) increases engagement between users and their pets by incorporating pets into the Christmas celebrations. Moreover, the artificial Christmas tree (100, 200, 300, 400, 500, 600, 700, 800) is repurposed for use as the cat tower 102, extending its utility beyond the holiday season and allowing it to be used for multiple years.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. An artificial Christmas tree, comprising:
a base;
a trunk disposed above the base, wherein the trunk is formed of one or more hollow members,
one or more platforms disposed at the trunk, wherein at least one platform is disposed within one or more hollow members, wherein the hollow members define a pathway therethrough, such that the pathway extends between two platforms and also from the base to one or more platforms disposed within or along the trunk;
at least one opening defined at one or more hollow members connected to the pathway, and
a decorative assembly configured to simulate at least one of natural foliage, branches, and ornamental structures, wherein the pathway is dimensioned to allow at least one animal to maneuver therethrough, wherein the platforms are arranged to serve as steps to facilitate movement of at least one animal through the pathway.

2. The artificial Christmas tree of claim 1, wherein the hollow members comprise a first hollow member, a second hollow member and a plurality of intermediate hollow members disposed between the first hollow member and the second hollow member, and wherein the first hollow member and the intermediate hollow members comprise a cylindrical configuration, and the second hollow member comprises a substantially conical configuration.

3. The artificial Christmas tree of claim 1, is configured to function as a cat tower, and wherein the animal includes cats.

4. The artificial Christmas tree of claim 1, wherein at least one platform is disposed within each hollow member and is configured to provide space for the animal to rest and play.

5. The artificial Christmas tree of claim 1, wherein at least one platform is disposed adjacent to the opening.

6. The artificial Christmas tree of claim 5, wherein each platform comprises a base portion, a first extended portion extending from the base portion and a second extended portion extends from a portion of an edge of the first extended portion, wherein the second extended portion extends perpendicular to the first extended portion, wherein the base portion extends from at least a portion of an interior surface of the hollow member and the first extended portion extends beyond the hollow member through the opening.

7. The artificial Christmas tree of claim 1, further comprises a first lock assembly configured to lock the hollow members to one another.

8. The artificial Christmas tree of claim 1, wherein the decorative assembly comprises a first branch assembly, wherein the first branch assembly is locked to the trunk via a second locking assembly.

9. The artificial Christmas tree of claim 8, wherein the first branch assembly comprising a first support member and one or more branch members extending from the first support member, wherein the branch member comprises a plurality of needles.

10. The artificial Christmas tree of claim 9, wherein the second lock assembly comprises one or more first bracket members, wherein the first bracket member comprises an elongated base member, one or more ridges extends along a length of the base member, and one or more hook members disposed at one end of the base member configured to hook onto the hollow member, wherein the first support member is complementary to the first bracket member configured to lock the first branch assembly with the second lock assembly.

11. The artificial Christmas tree of claim 1, wherein at least one platform is disposed on exterior surface of the hollow member, wherein the platform further comprises a second bracket member configured to lock to at least one of the trunk and the first bracket member.

12. The artificial Christmas tree of claim 1, wherein the decorative assembly comprises a branch assembly attached to the trunk using a hinged system, wherein the branch assembly automatically slide into designated place and fan out to form a spruce shape.

13. The artificial Christmas tree of claim 1, wherein the decorative assembly comprises a second branch assembly comprising a second support member and one or more branch members extending from the second support member, wherein the branch member comprises a plurality of needles.

14. The artificial Christmas tree of claim 13, wherein a distal end of the second support member comprises a bent portion, and wherein the distal end is inserted through an opening in the trunk such that the bent portion engages with a pair of grooves disposed along an interior or exterior surface of the trunk, thereby securing the support member in position.

15. The artificial Christmas tree of claim 1, wherein the decorative assembly comprises a third branch assembly comprises a third support member and one or more branch members extending from the third support member, wherein the third support member comprises at least one of circular configuration and curved configuration.

16. The artificial Christmas tree of claim 1, wherein the decorative assembly comprises a covering assembly comprising:
a plurality of panels arranged concentrically and vertically spaced apart to form a substantially tapered structure simulating a shape of a tree, and
at least one support structure associated with a central portion of a first panel of the plurality of panels, the support structure being configured to either (i) extend into a corresponding aperture at a top portion of the trunk or (ii) mate with and rest upon a top surface or peripheral platform of the trunk, wherein each panel comprises one or more opening portions to allow access to portions of the trunk, and the panels are configured to be collapsed into a compact arrangement and unfolded into a tree-like structure.

17. The artificial Christmas tree of claim 1, further comprises:
one or more ornaments disposed proximal to the platform;
a light assembly comprises a plurality of light emitting diodes (LED) disposed on the decorative assembly, and
a power source assembly connected to the light assembly.

18. An artificial Christmas tree, comprising:
a base;
at least one pole disposed above the base;
one or more platforms are arranged at different places on the pole, and
one or more branch assembly are arranged to extend from at least one of the pole and the platform, wherein the branches are arranged to form a pathway connecting the platforms, wherein the pathway is dimensioned to allow at least one animal to maneuver therethrough, and wherein the platforms are arranged to serve as steps to facilitate movement of at least one animal through the pathway.

19. The artificial Christmas tree of claim 18, wherein the pathway further comprises a first hollow member, a second hollow member and a plurality of intermediate hollow members disposed between the first hollow member and the second hollow member, wherein the first hollow member and the intermediate hollow members comprises a cylindrical configuration, and the second hollow member comprises a substantially conical configuration, and wherein the platform is configured to provide a space for the animal to rest and play.

20. The artificial Christmas tree of claim 18, further comprises:
one or more ornaments disposed proximal to the platform;
a light assembly comprises a plurality of light emitting diodes (LED) disposed on the decorative assembly, and
a power source assembly connected to the light assembly,
wherein the Christmas tree is configured to function as a cat tower, and wherein the animal includes cats.

21. The artificial Christmas tree of claim 1, wherein the decorative assembly comprises one or more branch assemblies that are removably attachable to the trunk using a bracket, hanger, or locking mechanism, wherein the trunk and platform assembly is configured for standalone use as a cat tower outside of seasonal use, and wherein the branch assemblies are stored separately when not in use.
